(19) United States
(12) Patent Application Publication
(10) Pub. No.: US 2001/0013780 A1
(43) Pub. Date: Aug. 16, 2001

(54) Composite alcohol testing pen

(76) Inventor: Wen-Jung Lin, Taipei (TW)

Correspondence Address: BACON & THOMAS, 625 Slaters Lane - 4th Floor, Alexandria, VA, 22314, US

(21) Appl. No.: 09/778,093

(22) Filed: Feb. 7, 2001

(30) Foreign Application Priority Data
Feb. 16, 2000 (TW) 89202470

(51) Int. Cl. G01N 27/62

(52) U.S. Cl. 324/464

(57) ABSTRACT

A composite alcohol testing pen includes a lower barrel (1), an upper barrel (2) and a gas detection device (3) The upper barrel (2) has a switch (21) and a light emitting diode (2) located at the outer surface, and a circuit board (4) and a battery (7) located inside. The circuit board (4) has an analyzing unit for analyzing alcohol concentration. The gas detection unit (3) receives breathing air from an users and detects the alcohol concentration contained therein.

### BACKGROUND OF THE INVENTION

This invention relates to a composite alcohol testing pen and particularly a testing pen that is capable of indicating excess alcohol concentration.

Pen is an indispensable stationery item in people's daily life. The fast paced technology innovation has given pen more versatile function other than writing. On the other hand, a lot of people have the habit of consuming some alcohol-contained drink. It could cause big trouble and serious consequence if people drive car with excess alcohol concentration in their blood. Instead of waiting to be stopped and tested by policeman, there is a small scale alcohol concentration testing devices being marketed to help people taking preventive measures. Because of that device is not a daily used article, people usually forget to carry it with them. As a result, it often is not available in the occasions where people need it.

### SUMMARY OF THE INVENTION

It is therefore an object of this invention to provide a composite pen that is capable of testing alcohol concentration in addition to the function of writing so that it is easy to carry and always ready for use whenever needed. The composite pen is able to indicate excess alcohol concentration level by color light rather than numerals, and is simpler and easier to use. It suits better for people living in modern time who pursue diversified and fast paced life style.

### BRIEF DESCRIPTION OF THE DRAWINGS

The invention, as well as its many advantages, may be further understood by the following detailed description and drawings.

FIG. 1 is a perspective of this invention.

FIG. 2 is an exploded of this invention.

### DESCRIPTION OF THE PREFERRED EMBODIMENT

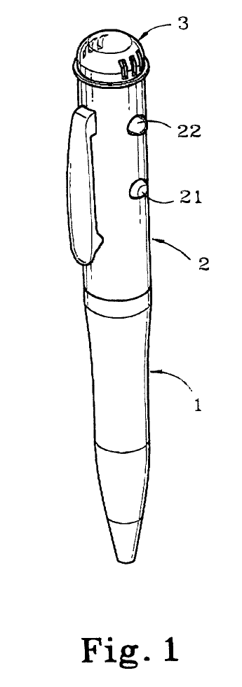

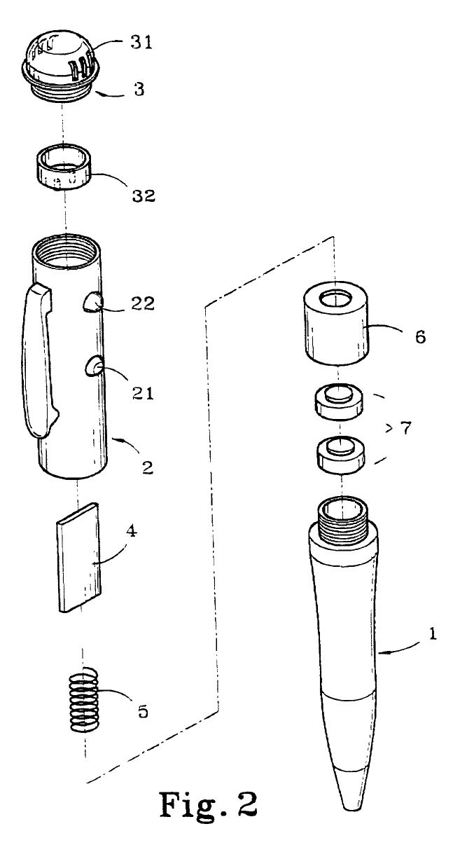

Referring to FIGS. 1 and 2, the composite pen according to this invention includes a lower barrel 1 which has a cartridge (not shown in the figures) and an upper barrel 2 engageable with the lower barrel 1. The upper barrel 2 further houses therein a circuit board 4 and a battery chamber 6 for containing battery 7 which may be No. 4 battery or mercury battery. The circuit board 4 links to the battery chamber 6 through an electrode 5. The circuit board 4 has an analyzing unit (not shown in the figures) and an automatic power off function. The analyzing unit may be a CPU or an IC and has a preset alcohol concentration value for analyzing alcohol concentration. The preset alcohol concentration value may be same as the one used by police officials. At the upper barrel 2, there are a switch 21 and a light emitting diode 22 located at the outside surface. The switch 21 and light emitting diode 22 link respectively to the circuit board 4.

On the upper barrel 2, there is further a gas detection device, which has a gas convection slot 3 land a sensor 32. The sensor 32 has a variable resistor connecting electrically to the circuit board 4 and may generate different voltage according to different alcohol concentration

When in use, turn on the switch 21 and sensor 32, breathe against the gas convection slot 31 . The sensor 32 receives the breathing air and will generate different voltage output depends on different alcohol concentration contained in the breathing air. The voltage will be transmitted to the circuit board 4. The analyzing unit compares and analyzes the received voltage value and preset value, and activates the light emitting diode 22 to generate light of different colors. When the alcohol testing function is not being used or the breathing air does not have alcohol content, the diode 22 does not generate light. When alcohol concentration in the breathing air is equal or greater than the preset value, the light emitting diode 22 will generate red light. When alcohol concentration in the breathing air is below the preset value, the light emitting diode 22 will generate green light. Hence users may easily do self test and be alerted of the actual situation

As the circuit board 4 has automatic power off function, once the alcohol concentration test is done, the circuit board 4 will be powered off automatically. Turning on the switch 21 may activate the circuit board 4 for performing another test.

What is claimed is:

1. A composite alcohol testing pen, comprising:
a lower barrel (1) having a cartridge located therein;
an upper barrel (2) engageable with the lower barrel (1) housing therein a circuit board (4) and a battery chamber (6), the circuit board (4) having an analyzing unit and an automatic power off function, the analyzing unit including a preset alcohol concentration value for analyzing alcohol concentration; the upper barrel (2) further having, a switch (21) and a light emitting diode (22) located at outer surface linking electrically to the circuit board (4);
a gas detection device (3) located on the upper barrel (2) having a gas convection slot (21) and a sensor (31) which has a variable resistor linking electrically to the circuit board (4) for generating different voltage according to different alcohol concentration;
wherein turning on the switch (21) will activate the sensor (31) to detect breathing air from an user through the gas convection slot (21) and generate different voltage according to alcohol concentration in the breathing air and the voltage will be transmitted to the circuit board (4) for the analyzing unit to compare and analyze the voltage with the preset value whereby to control the light emitting diode (2) to emit light of different colors to indicate alcohol concentration in the breathing air.

2. The composite alcohol testing pen of claim 1, wherein the light emitting diode (22) does not emit light when the breathing air does not have alcohol content, the light emitting diode (22) will emit red light when the alcohol concentration is greater than the preset value, and the light emitting diode (22) will emit green light when the breathing air has a lower alcohol concentration than the preset value.

3. The composite alcohol testing pen of claim 1, wherein the analyzing unit is a central process unit or an integrated circuit.

4. The composite alcohol testing pen of claim 1, wherein the circuit board (4) is automatically turned off when the test is completed. and turning on the switch (21) will activate the test function again, the switch (21) being a press switch.

5. The composite alcohol testing pen of claim 1, wherein the battery chamber (6) is for housing number four battery or mercury battery.

6. The composite alcohol testing pen of claim 1, wherein the circuit board (4) has an electrode (5) to link to the battery chamber (6).
